(19) United States
(12) Patent Application Publication
(10) Pub. No.: US 2006/0012649 A1
(43) Pub. Date: Jan. 19, 2006

(54) Inkjet head unit

(75) Inventor: Atsuo Sakaida, Gifu-shi (JP)

Correspondence Address: BANNER & WITCOFF, LTD.;Counsel for Brother Industries, 1001 G STREET, N.W., 11TH FLOOR, WASHINGTON, DC, 20001-4597, US

(73) Assignee: Brother Kogyo Kabushiki Kaisha, Nagoya-shi (JP)

(21) Appl. No.: 11/181,905

(22) Filed: Jul. 15, 2005

(30) Foreign Application Priority Data
Jul. 16, 2004 (JP) 2004-209848

(51) Int. Cl. B41J 2/045

(52) U.S. Cl. 347/72

(57) ABSTRACT

An inkjet head unit includes a printhead comprising: a flow-path unit having nozzles and pressure chambers communicated therewith; an actuator unit having a piezoelectric sheet extending across the chambers and having thereon individual electrodes positioned correspondingly to the chambers and a common electrode on the side opposite to the individual electrodes, the actuator unit being fixed to the flow-path unit to vary the volume of each chamber; a dielectric film formed on a surface of the actuator unit opposite to the flow-path unit to extend over regions corresponding and not corresponding to the chambers, the film having through-holes and a dielectric constant lower than that of the sheet; first wires formed on a surface of the film opposite to the actuator unit to extend in a substantially same direction; and second wires extending through the through-holes and connecting the respective individual electrodes to the first wires.

### INCORPORATION BY REFERENCE

The present application is based on Japanese Patent Application No. 2004-209848, filed on Jul. 16, 2004, the content of which is incorporated herein by reference.

### BACKGROUND OF THE INVENTION

1. Field of the Invention

The invention relates to an inkjet head unit including a printhead for ejecting droplets of ink onto a recording medium.

2. Description of the Related Art

As an inkjet head unit including a printhead which ejects ink droplets onto a sheet of paper or other recording media, there is known one which comprises a flow-path unit and a piezoelectric actuator unit. The flow-path unit has a plurality of pressure chambers and a plurality of nozzles respectively in communication with the pressure chambers so as to eject ink droplets therethrough. The piezoelectric actuator unit functions to pressurize ink in the pressure chambers by varying the inner volume of the pressure chambers. Such an inkjet head unit is disclosed in JP-A-11-334061 (see FIG. 2(a)), and JP-A-9-156099, for instance. A typical piezoelectric actuator unit includes a piezoelectric sheet extending across the pressure chambers, a plurality of individual electrodes disposed at respective positions corresponding to the pressure chambers, and a common electrode on the side of the piezoelectric sheet opposite to the individual electrodes. Upon application of a drive voltage to one of the individual electrodes, a portion of the piezoelectric sheet interposed between the individual electrode and the common electrode contracts by being affected by the electric field in the direction of the thickness of the piezoelectric sheet. Hence, the inner volume of the pressure chamber corresponding to the individual electrode changes, pressurizing the ink in the pressure chamber.

The individual electrodes are connected to wires so that the drive voltage is applied to the individual electrodes therethrough. In the inkjet head unit of the above-mentioned publication JP-A-11-334061, for instance, a plurality of upper electrodes arranged in matrix are respectively connected to a plurality of connecting terminals of a printed wiring board in which a pattern of wires is formed. In the inkjet head unit of the other publication JP-A-9-156099, a plurality of drive electrodes comprising a plurality of upper drive electrodes (individual electrodes) and a lower drive electrode (common electrode) are disposed on a piezoelectric sheet in a deformation region of the piezoelectric sheet, and a voltage is applied to the drive electrodes. A plurality of wires extend from the respective drive electrodes in a same direction into a wiring region on the piezoelectric sheet, to be connected to the printed wiring board there. The wiring region is adjacent to the deformation region where the piezoelectric sheet is interposed between the upper and lower drive electrodes. In order to prevent, creation of an unnecessary electrostatic capacity, upon application of voltage to an upper drive electrode, in the piezoelectric sheet at a portion interposed between a wire connected to that upper drive electrode and the lower drive electrode, a dielectric film having a relatively low dielectric constant is formed on the piezoelectric sheet across the wiring region and the wires are formed on a surface of the dielectric film opposite to the piezoelectric sheet.

In the inkjet head unit of the publication JP-A-11-334061, the printed wiring board is disposed to cover a matrix of the upper electrodes so that the upper electrodes are respectively connected to the connecting terminals of the printed wiring board. In this arrangement, when subjected to an external force, the printed wiring board tends to be separated from the upper electrodes. Thus, a reliability in the electrical connection between the printed wiring board and the upper electrodes is low.

According to the technique of the publication JP-A-9-156099, meanwhile, as long as the number of the pressure chambers are small, it is easy to form only within the wiring region the wires which extend from the individual electrodes disposed in the deformation region. However, where the number of the pressure chambers is increased, particularly where the pressure chambers are arranged in matrix, a part of the wires are inevitably formed in the deformation region as well as the wiring region. Since the dielectric film having the low dielectric constant is not provided in the deformation region, an unnecessary electrostatic capacity is created in the deformation region between the wire supplied with the voltage and the lower drive electrode or common electrode. The unnecessary electrostatic capacity deforms the piezoelectric sheet at the portion interposed between the wire to which the voltage is applied and the common electrode, leading to unintended deformation of the piezoelectric sheet at a place corresponding to a pressure chamber or chambers in the vicinity of that wire. That is, a crosstalk occurs, which varies the characteristics of ejection of ink droplets among the pressure chambers and accordingly among the nozzles, deteriorating the print quality. Further, in a case where a part of a wire connected to an individual electrode corresponding to a pressure chamber is disposed over another pressure chamber in order to ensure a sufficient spacing between each two adjacent wires in the deformation region, the electric field created around the wire to which the voltage is applied, directly affects a corresponding portion of the piezoelectric sheet over the another pressure chamber. In this case, the adverse influence of the crosstalk becomes serious at the another pressure chamber.

### SUMMARY OF THE INVENTION

The prevent invention has been developed in view of the above-described situations and it is an object of the invention to provide an inkjet head unit including a printhead capable of preventing creation of an unnecessary electrostatic capacity and occurrence of a crosstalk.

To obtain the above object, this invention provides an inkjet head unit including a printhead comprising:

a flow-path unit having a plurality of nozzles and a plurality of pressure chambers respectively in communication with the nozzles;

an actuator unit having a piezoelectric sheet extending across the pressure chambers, a plurality of individual electrodes disposed on the piezoelectric sheet at respective positions corresponding to the pressure chambers, and a common electrode which is disposed on a surface of the piezoelectric sheet opposite to the individual electrodes, the actuator unit being fixed on a surface of the flow-path unit to vary the inner volume of each of the pressure chambers;

a dielectric film continuously formed on a surface of the actuator unit opposite to the flow-path unit, to extend over a first region not corresponding positionally to the pressure chambers as well as over a second region corresponding positionally to the pressure chambers, the dielectric film having a plurality of through-holes, and a dielectric constant of the dielectric film being lower than that of the piezoelectric sheet;

a plurality of first wires formed on a surface of the dielectric film opposite to the actuator unit, to extend in a substantially same direction; and

a plurality of second wires extending through the through-holes of the dielectric film, and connecting the respective individual electrodes to the first wires.

In this inkjet head unit, upon selective application of the voltage to one of the individual electrodes of the actuator unit of the printhead, a portion of the piezoelectric sheet interposed between the common electrode and the individual electrode to which the voltage is applied is affected by the electric field in the direction of the thickness of the piezoelectric sheet, and deformed. This deformation changes the inner volume of the corresponding pressure chamber to pressurize the ink therein, thereby ejecting an ink droplet from the nozzle in communication with the pressure chamber.

On the surface of the actuator unit remote from the flow-path unit, there is formed the dielectric film having a dielectric constant lower than that of the piezoelectric sheet. On the surface of the dielectric film opposite to the actuator unit, there are formed the first wires for the respective individual electrodes. Each of the first wires and the corresponding individual electrode are connected to each other via the second wire extending through one of the through-holes formed through the dielectric film.

In this way, the dielectric film having the dielectric constant lower than that of the piezoelectric sheet is interposed between the piezoelectric sheet and the first wires. Hence, when the voltage is applied to one of the individual electrodes via the corresponding first and second wires, an unnecessary electrostatic capacity is not created, thereby improving the driving efficiency of the actuator unit. Since there is minimized the deformation due to the unnecessary electrostatic capacity, in the piezoelectric sheet at a portion between the common electrode and the first wire to which the voltage is applied, occurrence of the crosstalk with the pressure chamber(s) in the vicinity of the first wire to which the voltage is applied is prevented.

The dielectric film is continuously formed on the actuator unit over the first region not corresponding positionally to the pressure chambers, as well as over the second region corresponding positionally to the pressure chambers. Hence, even where a first wire for an individual electrode corresponding to one of the pressure chambers is disposed over another pressure chamber, the deformation in the piezoelectric sheet at the portion over the another pressure chamber due to the application of the voltage to the first wire is minimized, preventing the crosstalk due to presence of the first wire over the another pressure chamber. As a consequence, it is enabled to dispose the first wires in the second region positionally corresponding to the pressure chambers also, thereby increasing the space for arranging the first wires. This enables to widen the spacing between each adjacent two of the first wires, facilitating the formation of the first wires, in turn enabling reduction in the manufacturing cost of the actuator unit or the printhead. The first wires extend in a substantially same direction so that ends of the first wires on a same side are collected in an area at which the first wires are connected to a wiring member such as a flexible printed wiring board, which may be referred to as a flexible printed circuit (FPC). According to this arrangement, the first wires are easily connected to the wiring member, thereby improving the reliability of the connection therebetween.

### BRIEF DESCRIPTION OF THE DRAWINGS

The above and other objects, features, advantages and technical and industrial significance of the present invention will be better understood by reading the following detailed description of preferred embodiments of the invention, when considered in connection with the accompanying drawings, in which:

FIG. 1 is a perspective view showing an inkjet head unit to which a principle of the present invention is applied;

FIG. 2 is a cross sectional view taken along line 2-2 in FIG. 1;

FIG. 3 is a plan view showing an inkjet printhead of the inkjet head unit of FIG. 1;

FIG. 4 is an enlarged view of an area enclosed with one-dot chain line in FIG. 3;

FIG. 5 is an enlarged view of an area enclosed with one-dot chain line in FIG. 4;

FIG. 6 is a cross sectional view taken along line 6-6 in FIG. 5;

FIG. 7 is an enlarged plan view schematically showing a part of an actuator unit of the printhead;

FIG. 8 is a cross sectional view taken along line 8-8 in FIG. 7;

FIG. 9 is an enlarged plan view schematically showing a part of an actuator unit of a printhead of an inkjet head unit according to a second embodiment of the invention;

FIG. 10 is an enlarged plan view schematically showing a part of an actuator unit of a printhead of an inkjet head unit according to a third embodiment of the invention; and

FIG. 11 is an enlarged plan view schematically showing a part of an actuator unit of a printhead of an inkjet head unit according to a fourth embodiment of the invention.

### DETAILED DESCRIPTION OF PREFERRED EMBODIMENTS

Hereinafter, there will be described presently preferred embodiments of the invention, by referring to the accompanying drawings.

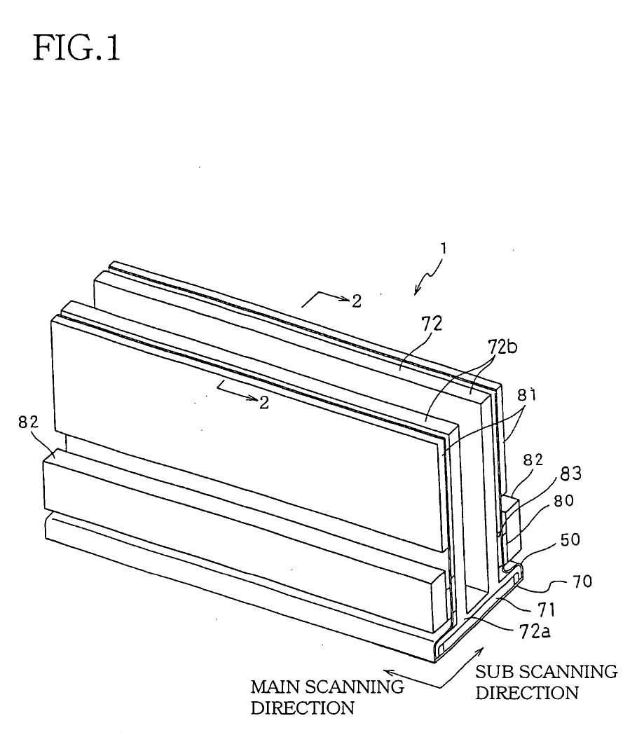

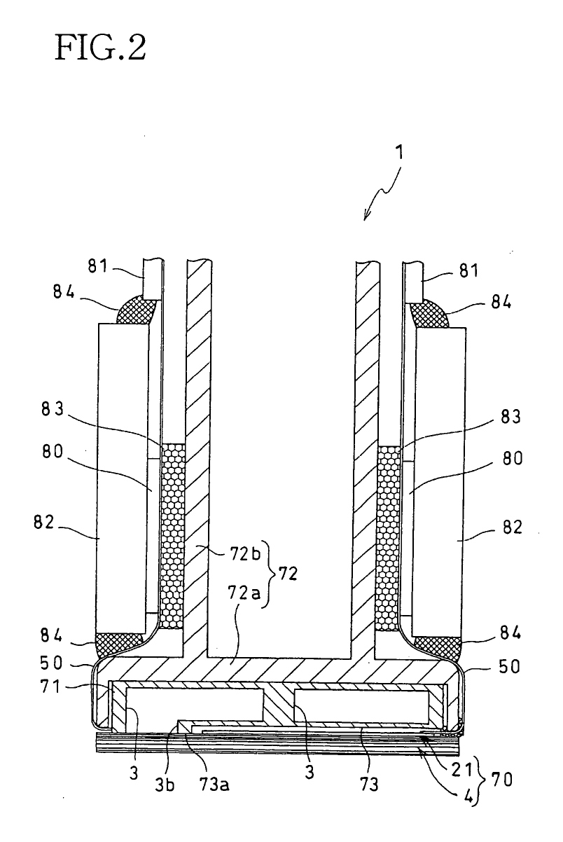

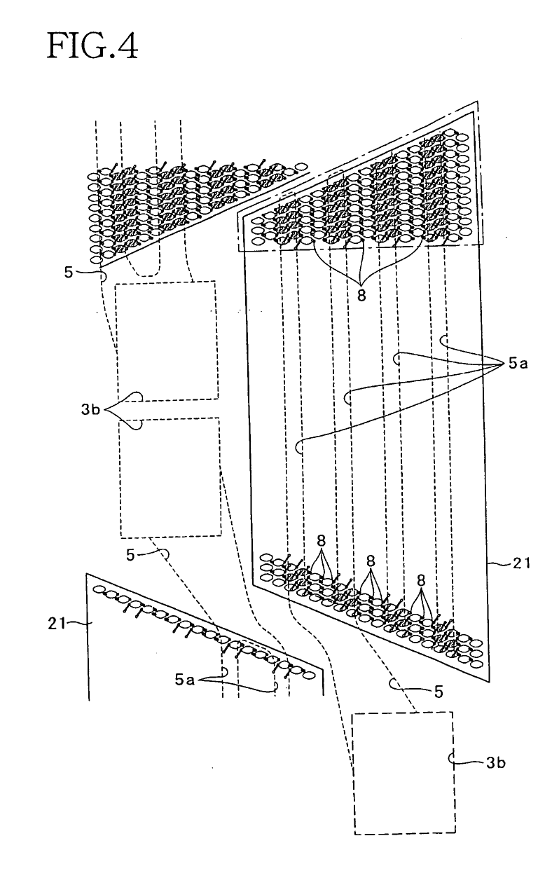

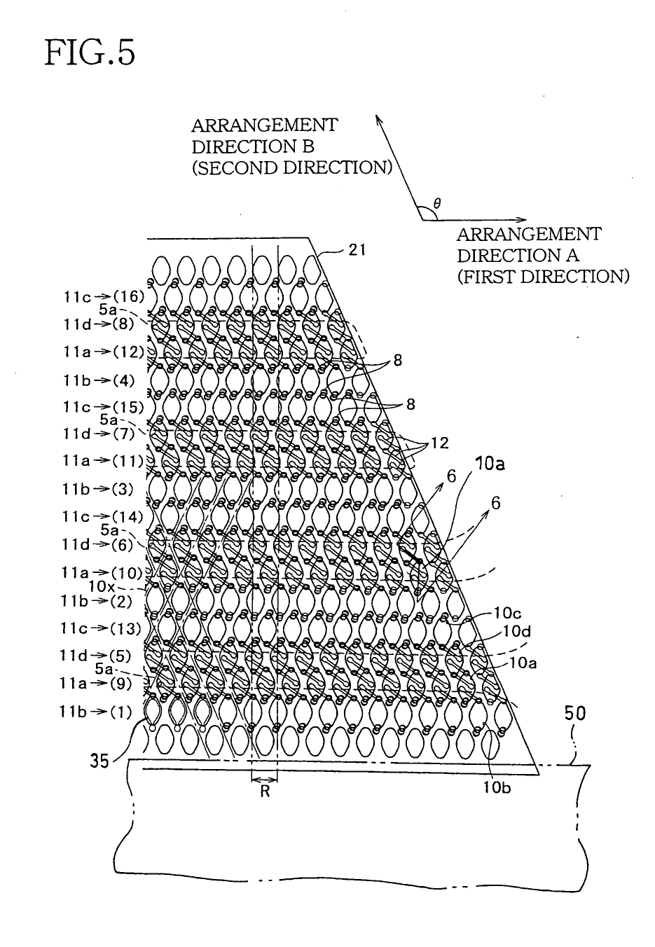

Referring to FIGS. 1 to 8, there will be described an inkjet head unit according to a first embodiment of the invention. In FIGS. 1 and 2, reference numeral 1 generally denotes the inkjet head unit which is disposed in an inkjet printer (not shown) for ejecting ink droplets onto a recording medium in the form of a sheet of paper so as to. record information or an image thereon. The inkjet head unit 1 includes: an inkjet printhead 70 which has, in plan view, a rectangular shape extending in a main scanning direction and a plurality of nozzles 8 (FIGS. 4 and 5) through which ink is ejected toward the sheet of paper; and a base block 71 which is disposed above the printhead 70 and in which are formed two ink reservoirs 3, 3 each functioning as a flow passage of ink to be supplied to the printhead 70.

The printhead 70 includes: a flow-path unit 4 in which ink paths are formed; and a plurality of actuator units 21 bonded to an upper surface of the flow-path unit 4. Each of the ink-flow path unit 4 and a plurality of actuator units 21 is formed such that a plurality of thin plates are stacked on and bonded to one another. As shown in FIG. 2, an end portion of each of the actuator units 21 is bonded to one of two flexible printed wiring boards 50 (hereinafter referred to as “FPCs 50” as explained in the “Description of the Related Art”) which are drawn out to both sides. The base block 71 is formed of a metal such as stainless steel, for instance. Each of the ink reservoirs 3, 3 formed in the base block 71 is a substantially rectangular parallelepiped hollow region extending in a longitudinal direction of the base block 71.

A lower surface 73 of the base block 71 protrudes downward at portions 73a thereof in the vicinity of openings 3b. The portions 73a may be hereinafter referred to as the “opening-vicinity portions 73a”. The base block 71 is in contact with the flow-path unit 4 only at the opening-vicinity portions 73a of its lower surface 73. Thus, regions of the lower surface 73 of the base block 71 other than the opening-vicinity portions 73a are spaced apart from the printhead 70, and the actuator units 21 are disposed within the space between the printhead 70 and the lower surface 73 of the base block 71 at the above-indicated spaced regions thereof.

The base block 71 is accommodated in a recess formed in a lower surface of a holding portion 72a of a holder 72 and is bonded and fixed to the holding portion 72a. The holder 72 includes the holding portion 72a and a pair of tabular projecting portions 72b extending from an upper surface of the holding portion 72a in an upward direction perpendicular to the upper surface, so as to be opposed to each other with a predetermined distance therebetween. Each of the two FPCs 50 bonded to the actuator units 21 extends along the outer surface of the projecting portion 72b with an elastic member 83 such as a sponge interposed therebetween. Driver ICs 80 are mounted on the respective FPCs 50 disposed along the surfaces of the projecting portions 72b of the holder 72. Each FPC 50 is electrically connected by soldering to both of the driver IC 80 and the actuator units 21 (described later) of the printhead 70 in order to transmit operating signals outputted from the driver IC 80 to the actuator units 21.

Heat sinks 82 each having a substantially rectangular parallelepiped shape are disposed to be in close contact with the respective driver ICs 80, whereby heat generated at the driver ICs 80 is dissipated through the heat sinks 82. At each side, above the driver IC 80 and the heat sink 82 and on the outer side of the FPC 50, there is disposed a substrate 81. A seal member 84 is provided between the upper surface of each heat sink 82 and the substrate 81 on the same side, and between the lower surface of each heat sink 82 and the FPC 50 on the same side.

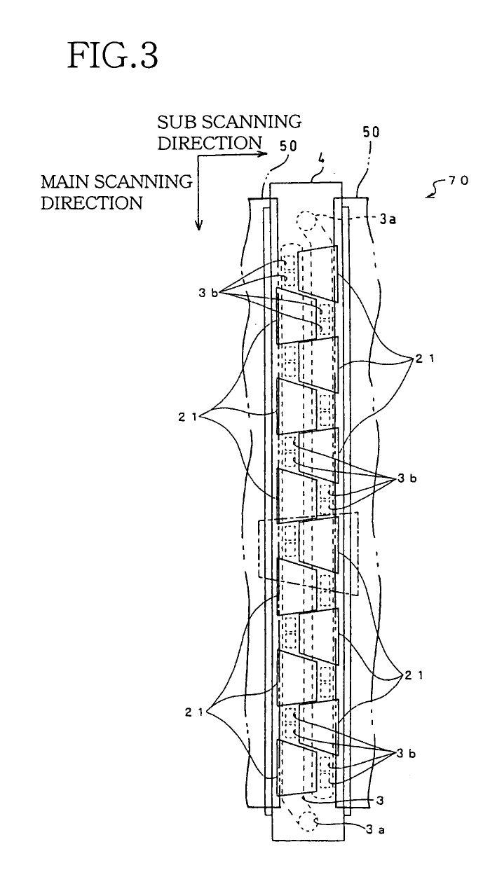

FIG. 3 is a plan view of the printhead 70 shown in FIG. 1. In FIG. 3, each ink reservoir 3 formed in the base block 71 is virtually illustrated by broken line. The two ink reservoirs 3, 3 extend in a longitudinal direction of the printhead 70 so as to be in parallel to each other with a predetermined spacing therebetween. At one of opposite ends of each ink reservoir 3, there is formed an end opening 3a through which the ink reservoir 3 communicates with an ink tank (not shown) so as to be filled with ink. Each ink reservoir 3 is formed with a plurality of openings 3b which align in the longitudinal direction of the printhead 70. The ink reservoirs 3, 3 and the flow-path unit 4 are connected to each other through the openings 3b. The openings 3b are formed in a plurality of pairs, and two openings 3b of each pair are disposed adjacent to each other along the longitudinal direction of the printhead 70. The pairs of openings 3b communicating with one of the two ink reservoirs 3 and the pairs of openings 3b communicating with the other ink reservoir 3 are arranged in a zigzag pattern in plan view.

The actuator units 21 each having a trapezoidal shape in plan view are provided on regions of the upper surface of the flow-path unit 4 which do not correspond to the openings 3b, such that the actuator units 21 are arranged in a zigzag pattern opposite to that of the pairs of openings 3b. Parallel opposed sides (short and long sides) of each actuator unit 21 are parallel to the longitudinal direction of the printhead 70, and oblique sides of adjacent actuator units 21 partially overlap as viewed in the main scanning direction. As shown in FIG. 3, the left end portions of the respective actuator units 21 disposed at the left-hand side are bonded to one of the two FPCs 50, and the right end portions of the respective actuator units 21 disposed at the right-hand side are bonded to the other FPC 50.

FIG. 4 is a view showing in enlargement an area enclosed with one-dot chain line in FIG. 3. As shown in FIG. 4, the openings 3b provided for each of the ink reservoirs 3 communicate with respective manifolds 5. Each manifold 5 is branched into two sub manifolds 5a each as a common ink chamber. Two branched sub manifolds 5a extend from one of two openings 3b which are located on opposite sides of the two oblique sides of each actuator unit 21, and another two branched sub manifolds 5a extend from the other of the two openings 3b. Thus, in plan view, four sub manifolds 5a in total extend below each actuator unit 21 along the two parallel sides of the same 21 so as to be spaced apart from one another.

On the lower surface of the flow-path unit 4, there are formed a plurality of ink ejection regions in each of which a multiplicity of nozzles 8 are arranged in matrix as described below. While only some of the nozzles 8 are illustrated in FIG. 4 in the interest of brevity, the nozzles 8 are actually arranged all over each ink ejection region.

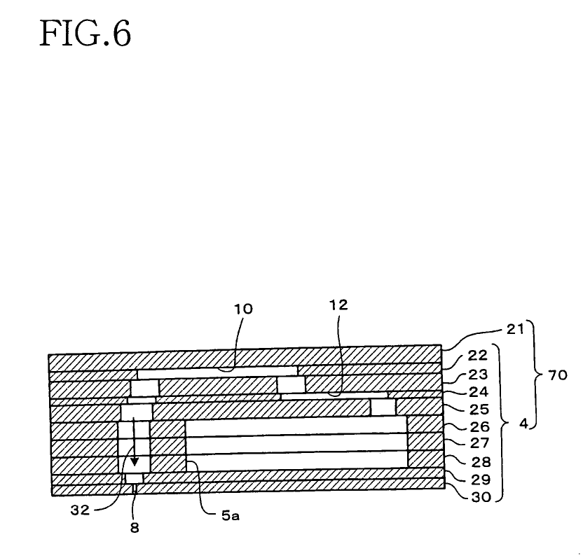

FIG. 5 is an enlarged view of an area enclosed with one-dot chain line in FIG. 4. FIGS. 4 and 5 show a state wherein a plane on which a multiplicity of pressure chambers 10 of the flow-path unit 4 are arranged in matrix is viewed in a direction perpendicular to the ink ejection surface of the printhead 70. Each of the pressure chambers 10 has, in plan view, a substantially rhombic shape having rounded corners. The long diagonal line of each rhombic pressure chamber 10 is parallel to a widthwise direction of the flow-path unit 4. As shown in FIG. 6, one end of each pressure chamber 10 communicates with a corresponding nozzle 8 and the other end thereof communicates, via a corresponding aperture 12, with a corresponding sub manifold 5a as a common ink chamber. A plurality of individual electrodes 35 are formed on each actuator unit 21 at positions which overlap the respective pressure chambers 10 in plan view. Each individual electrode 35a has, in plan view, a shape which is similar to that of the pressure chamber 10, and whose size is slightly smaller than that of the pressure chamber 10. For the sake of simplicity, only some of the individual electrodes 35 are illustrated in FIG. 5. Further, the pressure chambers 10, the apertures 12, etc., which are in the actuator units 21 or the flow-path unit 4 and which should be expressed by broken line are illustrated in solid line in FIGS. 4 and 5.

In FIG. 5, a plurality of imaginary rhombic areas 10x in which the respective pressure chambers 10 (10a, 10b, 10c, 10d) are accommodated are arranged adjacent to one another in matrix in two directions, i.e., an arrangement direction A and an arrangement direction B, such that adjacent rhombic areas 10x do not overlap with one another and have respective sides in common. The arrangement direction A is a longitudinal direction of the printhead 70, i.e., a direction of extension of each sub manifold 5a, and parallel to a short diagonal line of each rhombic area 10x. The arrangement direction B is a direction of one oblique side of each rhombic area 10x that forms an obtuse angle θ with respect to the arrangement direction A. The center position of each pressure chamber 10 is common to that of the corresponding rhombic area 10x, and the contour line of each pressure chamber 10 is separated from that of the corresponding rhombic area 10x in plan view.

The pressure chambers 10 arranged adjacent to one another in matrix in the two arrangement directions A and B are spaced apart from each other by a distance R corresponding to 37.5 dpi in the arrangement direction A. In the present embodiment, eighteen pressure chambers 10 are arranged in one row in the arrangement direction B in one ink ejection region. The pressure chambers 10 located at opposite ends in the arrangement direction B are dummy chambers that do not contribute to ink ejection.

The plurality of pressure chambers 10 formed in matrix constitute a plurality of pressure-chamber rows along the arrangement direction A, as shown in FIG. 5. The direction in which each pressure-chamber row extends is perpendicular to the long diagonal line of the rhombic shape of the pressure chambers. The plurality of pressure-chamber rows are classified into a first pressure-chamber row 11a, a second pressure-chamber row 11b, a third pressure-chamber row 11c, and a fourth pressure-chamber row 11d in accordance with their positions relative to the sub manifolds 5a, as viewed in a direction perpendicular to the sheet surface of FIG. 5. Each of the first through fourth pressure-chamber rows 11a-11d are disposed periodically four times in order of 11c, 11d, 11a, 11b, 11c, 11d, 11b, from the short side of the parallel opposed sides (hereinafter referred to as “the shorter base”) of the actuator unit 21 toward the long side (hereinafter referred to as “the longer base”).

In the pressure chambers 10a constituting the first pressure-chamber row 11a and the pressure chambers 10b constituting the second pressure-chamber row 11b, the nozzles 8 are located at a lower end of each pressure chamber 10a, 10b nearer to the lower side of the sheet surface of FIG. 5, with respect to a vertical direction in FIG. 5 perpendicular to the arrangement direction A, as viewed in the direction perpendicular to the sheet surface of FIG. 5. Namely, the nozzles 8 of the pressure chambers 10a, 10b are located at respective lower ends of the corresponding rhombic areas 10x, as seen in the vertical direction in FIG. 5. On the other hand, in the pressure chambers 10c constituting the third pressure-chamber row 11c and the pressure chambers 10d constituting the fourth pressure-chamber row 11d, the nozzles 8 are located at an upper end of each pressure chamber 10c, 10d nearer to the upper side of the sheet surface of FIG. 5, with respect to the vertical direction in FIG. 5 perpendicular to the arrangement direction A, as viewed in the direction perpendicular to the sheet surface of FIG. 5. Namely, the nozzles 8 of the pressure chambers 10c, 10d are located at respective upper ends of the corresponding rhombic areas 10x, as seen in the vertical direction in FIG. 5. In the first and fourth pressure-chamber rows 11a, 11d, half or more of the region of each pressure chamber 10a, 10d overlaps the corresponding sub manifold 5a, as viewed in the direction perpendicular to the sheet surface of FIG. 5. In the second and third pressure-chamber rows 11b, 11c, the entire region of each pressure chamber 11c, 11d does not overlap any sub manifolds 5a. Accordingly, the pressure chambers 10 belonging to any of the pressure-chamber rows 11a-11d can be formed such that the nozzles 8 communicating with the corresponding pressure chambers 10 do not overlap the sub manifolds 5a while making the width of the sub manifolds 5a as large as possible, whereby the ink can be smoothly supplied to the pressure chambers 10.

Referring next to FIG. 6, which is a cross sectional view taken along line 6-6 in FIG. 5, there will be explained a sectional structure of the printhead 70. As shown in FIG. 6, each nozzle 8 communicates with the corresponding sub manifold 5a through the corresponding pressure chamber 10 and the corresponding aperture 12. Thus, in the printhead 70, there is formed, for each pressure chamber 10, an individual ink path 32 extending from an outlet of the sub manifold 5a to the nozzle 8 through the aperture 12 and the pressure chamber 10.

The printhead 70 has a laminar structure in which ten plates in total are stacked or superposed on one another. The ten plates consist of the actuator unit 21 and nine plates constituting the flow-path unit 4, namely, a cavity plate 22, a base plate 23, an aperture plate 24, a supply plate 25, manifold plates 26 27, 28, a cover plate 29, and a nozzle plate 30.

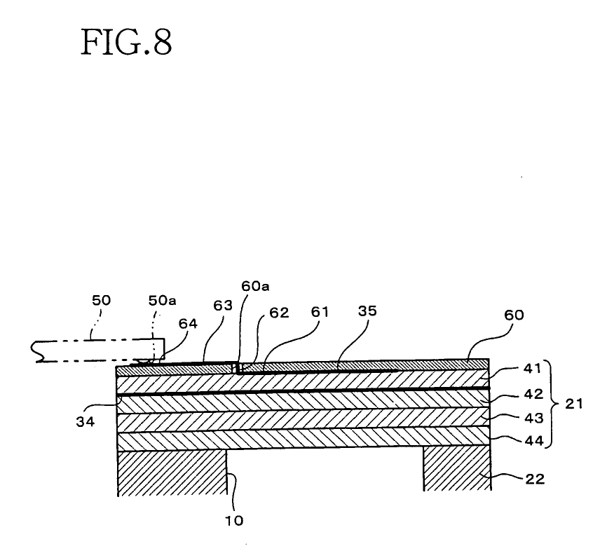

Each actuator unit 21 includes four piezoelectric sheets 41-44 (FIG. 8) which are stacked on one another and is provided with electrodes, so that only an uppermost sheet among the four piezoelectric sheets 41-44 serves as an active layer including active portions each of which becomes active at the time of application of an electric field, and the rest of three layers or sheets are non-active layers. The cavity plate 22 is a metal plate in which are formed a multiplicity of openings in a substantially rhombic shape in plan view that give the respective pressure chambers 10. The base plate 23 is a metal plate in which are formed, for one pressure chamber 10 of the cavity plate 22, a communication hole between the pressure chamber 10 and the corresponding aperture 12 and a communication hole for communication between the pressure chamber 10 and the corresponding nozzle 8. The aperture plate 24 is a metal plate in which are formed, for one pressure chamber 10 of the cavity plate 22, the aperture 12 constituted by two holes and a half-etched part connecting the two holes, and a communication hole for communication between the pressure chamber 10 and the corresponding nozzle 8. The supply plate 25 is a metal plate in which are formed, for one pressure chambers 10 of the cavity plate 22, a communication hole between the corresponding aperture 12 and the corresponding sub manifold 5a and a communication hole for communication between the pressure chamber 10 and the corresponding nozzle 8. The manifold plates 26, 27, 28 are metal plates and have, for one pressure chamber 10, respective communication holes for communication between the pressure chamber 10 and the corresponding nozzle 8, in addition to cutouts which cooperate to form the sub manifolds 5a when these manifold plates 26-28 are stacked. The cover plate 29 is a metal plate in which is formed, for one pressure chamber 10, a communication hole for communication between the pressure chamber 10 and the corresponding nozzle 8. The nozzle plate 30 is a metal plate in which is formed, for one pressure chamber 10, a hole which gives the corresponding nozzle 8.

These nine plates 22-30 of the flow-path unit are stacked on one another while being positioned relative to one another so as to define the individual ink paths 32 one of which is shown in FIG. 6. Each individual ink path 32 extends first upward from the sub manifold 5a, then extends horizontally at the aperture 12, further extends upward, then again extends horizontally at the pressure chamber 10, extends obliquely in a downward direction so as to be away from the aperture 12, and extends vertically downward toward the nozzle 8.

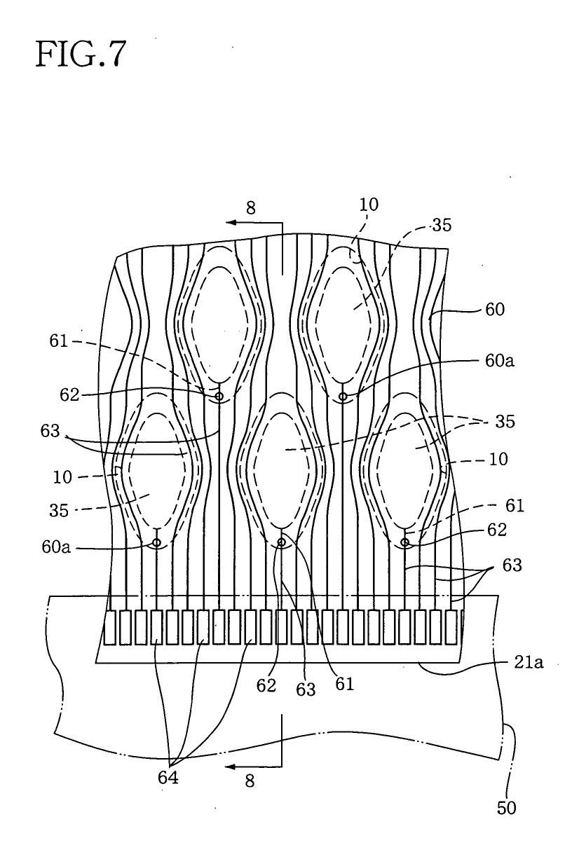

Referring next to FIGS. 7 and 8, there will be explained a structure of each actuator unit 21 superposed on the cavity plate 22 which is the uppermost plate of the flow-path unit 4. FIG. 7 is a fragmentary plan view showing in enlargement the end portion of the actuator unit 21 at which the actuator unit 21 is bonded to the FPC 50, and FIG. 8 is a cross sectional view taken along line 8-8 in FIG. 7. As shown in FIGS. 7 and 8, the actuator unit 21 comprises four piezoelectric sheets 41-44 extending across the pressure chambers 10, the individual electrodes 35 disposed on the uppermost piezoelectric sheet 41 at respective positions corresponding to the pressure chambers 10, and a common electrode 34 disposed on the side of the uppermost piezoelectric sheet 41 opposite to the individual electrodes 35.

The four piezoelectric sheets 41, 42, 43, 44 have a substantially same thickness of about 15 μm. These piezoelectric sheets 41-44 are formed as a layered flat plate (consisting of continuous flat layers) which continuously extends over the multiplicity of pressure chambers 10 formed in one ink ejection region in the printhead 70. Since the piezoelectric sheets 41-44 extend over the multiplicity of pressure chambers 10 as the continuous flat layers, the individual electrodes 35 can be disposed at high density on the piezoelectric sheet 41 by screen printing, for instance. Further, the pressure chambers 10 formed at positions corresponding to the respective individual electrodes 35 can also be disposed at high density, whereby high-resolution image printing can be achieved. The piezoelectric sheets 41-44 are formed of a ceramic material of lead zirconate titanate (PZT) having ferroelectricity.

As shown in FIG. 7, each individual electrode 35 has, in plan view, a rhombic shape similar to, but slightly smaller than, that of the pressure chamber 10. The individual electrodes 35 are formed on the uppermost one 41 of the piezoelectric sheets 41-44 such that each individual electrode 35 is located within an outline of the corresponding one of the pressure chambers 10, in plan view. Accordingly, the individual electrodes 35 are arranged in matrix on the upper surface of the piezoelectric sheet 41, in a fashion similar to the pressure chambers 10. The thickness of the individual electrodes 35 is about 1 μm, for instance.

The common electrode 34 is formed between the uppermost piezoelectric sheet 41 and the second uppermost piezoelectric sheet 42, to extend over the entire areas of the piezoelectric sheets 41, 42. The thickness of the common electrode 34 is about 2 μm, for instance. The common electrode 34 is grounded at a place not shown, and thus maintained at the ground potential at every place corresponding to any pressure chamber 10.

Both the individual and common electrodes 35, 34 are made of a metal material such as Ag—Pd based metal material, for instance.

In this inkjet printhead 70, a dielectric film 60 is formed over the entire area of an upper surface of the actuator unit 21 which is the surface thereof opposite to the flow-path unit 4. That is, the dielectric film 60 is formed across the individual electrodes 35. The dielectric film 60 has a dielectric constant lower than that of the piezoelectric sheets 41-44, and is preferably made of a low-k (low dielectric constant) material having a dielectric constant which is not larger than 1/100 of that of the piezoelectric sheets 41-44. In the present embodiment, the relative dielectric constant of the piezoelectric sheets 41-44 is about 3500. Hence, the relative dielectric constant of the material forming the dielectric film 60 should be about a few dozen. By the provision of the dielectric film 60 having such a dielectric constant, the driving efficiency of the actuator unit 21 is enhanced, while the crosstalk is effectively prevented.

The dielectric film 60 may be formed by a known method with a relatively inexpensive material. For instance, the dielectric film 60 may be formed of glass material which is deposited by chemical vapor deposition (CVD), or formed of fluoro resin by printing. By employing a relatively inexpensive material such as glass and resin as the material of the insulating film or the dielectric film 60, the manufacturing cost of the printhead is reduced.

The thickness of the dielectric film 60 is about 0.5 to 2 μm, for instance.

At a part in the dielectric film 60 corresponding to a lower side one, as seen in FIG. 7, of two acute portions of each rhombic pressure chamber 10, there is formed a through-hole 60a extending through the thickness of the dielectric film 60.

A connecting wire 61 extends from a lower end portion, as seen in FIG. 7, of each substantially rhombic individual electrode 35, and this connecting wire 61 is connected to a vertical wire 62 (constituting a second wire) disposed inside the through-hole 60a to extend through the thickness of the dielectric film 60.

The through-hole 60a is formed at the position as described above, since upon application of the voltage to an individual electrode 35, a portion of the piezoelectric sheet 41 positionally corresponding to each of two longitudinal end portions of the pressure chamber 10 corresponding to that individual electrode does not easily deform. That is, the through-hole 60a is formed at a position where the piezoelectric sheet 41 is the least deformable in an area of the pressure chamber 10, so that the individual electrode 35 is connected to the vertical wire 62 at a place where the piezoelectric sheet 41 is the least deformable. According to this arrangement, deformation of the piezoelectric sheet 41 is not inhibited by presence of the connection between the individual electrode 35 and the vertical wire 62. In order to obtain such an effect, this arrangement is equally applicable to any cases where the shape of the pressure chamber in plan view is elongate, that is, not only where the pressure chamber has a rhombic shape or an elongate quadrilateral with two acute portions at its longitudinal ends, as in the present embodiment, but also where the pressure chamber has any other elongate shapes in plan view.

Each of the vertical wires 62 is connected to a surface wire 63 (constituting a first wire). As shown in FIG. 7, the surface wires 63 are disposed on the dielectric film 60 such that a part of each of the surface wires 63 (strictly, except the surface wires 63 extending from the individual electrodes 35 aligned at the edge of the actuator unit 21 on the side to be connected to the FPC 50) is located over one or more pressure chambers 10 different than the one from which the surface wire 63 extends from, but not over any individual electrode 35. The surface wires 63 extend in the same direction, namely, the direction of the long diagonal line of the pressure chambers 10 toward the lower side in FIG. 7, and ends of the surface wires 63 on this side are connected to respective connecting terminals 64 for connection with the FPC 50. The connecting terminals 64 are disposed in an area (constituting a second area) extending adjacent and along the longer base 21a of the trapezoidal shape of the actuator unit 21. This area extends along a side of another area (constituting a first area) in which a group of the individual electrodes are arranged. As shown in FIGS. 7 and 8, the FPC 50 is connected to the connecting terminals 64 through its connecting lands 50a, with an edge of the FPC 50 parallel to the longer base 21a of the trapezoidal shape of the actuator unit 21. Each individual electrode 35 is electrically connected to one of the drivers IC 80, via the connecting, vertical and surface wires 61, 62, 63, and a lead wire formed in the FPC 50. When it is requested to eject an ink droplet from a nozzle 8, the driver IC 80 selectively applies a voltage to one of the individual electrodes 35 which corresponds to the nozzle 8.

According to this arrangement, the individual electrodes 35 and the FPC 50 (as a wiring member) are connected via the surface wires 63 (each constituting the first wire) such that the ends of the surface wires 63 are collected in an area so that the FPC 50 is connected to the surface wires 63 at this area. Compared with an arrangement where the wiring member is connected with the actuator unit or its electrodes, in a state such that the surface of the wiring member is parallel to the surface of the actuator unit, as in the above-mentioned publication JP-A-11-334061, the present arrangement makes it easier to connect the individual electrodes to the wiring member in the form of the FPC 50, via the surface wires 63, while enhancing the reliability of the connection therebetween.

It is noted that in FIG. 7 only a part of all the surface wires 63 actually provided is shown. In other words, in an actual printhead, the number of the surface wires 63 and accordingly the number of the connecting terminals 64 are double the numbers of those represented in FIG. 7.

As described above, between the piezoelectric sheet 41 and each of the surface wires 63 connected to the individual electrodes 35, there is interposed the dielectric film 60 made of a low-k material. Hence, upon application of a voltage to one of the individual electrodes 35 via its corresponding surface wire 63, the electric field acting on a portion of the piezoelectric sheet 41 beneath that surface wire 63 is minimized. Further, the unnecessary electrostatic capacity, i.e. a parasitic capacity, created at the portion of the piezoelectric sheet 41 with respect to that surface wire 63 is also minimized.

In contrast to the present arrangement, in a case where the dielectric film 60 is not employed, and the pressure chambers 10 are arranged in matrix in a fashion similar to the present printhead 70 shown in FIG. 5, even when the surface wires 63 are disposed not to be located over any pressure chamber 10 in order to prevent deformation of the pressure chambers 10 due to presence of the surface wires 63 over the pressure chambers 10, an electric field depending on the distance between the common electrode 34 and each individual electrode 35 is produced around each surface wire 63, thereby deforming the piezoelectric sheet 41 at the place interposed between the common electrode 34 and the each individual electrode 35. Thus, a crosstalk occurs. Further, parasitic capacities with respect to the surface wires 63 depending on the way of arrangement of the surface wires 63 are generated, and therefore a variation occurs in the phase and waveform of the voltage applied by the driver IC 80. The degree of the variation in the phase and waveform of the voltage differs depending on the distance of extension of the surface wires 63, for instance, and thus the printhead 70 suffers from an inconvenience that the ink ejection characteristics varies among the pressure chambers 10 respectively corresponding to the surface wires 63.

In the printhead 70 of the preset embodiment, on the other hand, the electric field acting on the piezoelectric sheet 41 at the unintended portion upon voltage application to a surface wire 63 is extremely weak, and the crosstalk with the pressure chamber or chambers 10 in the vicinity of that surface wire 63 is prevented. Further, since the parasitic capacities created for the respective surface wires 63 are also extremely small, the ink ejection characteristics is uniform among the pressure chambers 10.

The dielectric film 60 is formed at a region positionally corresponding to the pressure chambers 10, as well as a region corresponding to the interspace between the pressure chambers 10. Hence, even when a surface wire 63 connected to an individual electrode 35 corresponding to one of the pressure chambers 10 is disposed over another pressure chamber 10, there is minimized the deformation of the piezoelectric sheet 41 at the portion corresponding to the another pressure chamber 10 upon voltage application to that surface wire 63, thereby preventing the crosstalk which would be otherwise caused by presence of that surface wire 63 over the another pressure chamber 10. Since the surface wires 63 are allowed to be located over the pressure chambers 10, it is enabled to widen the spacing between the surface wires 63. This facilitates formation of the surface wires 63.

As shown in FIG. 7, the through-hole 60a is formed within an area of the pressure chamber 10, in plan view. Accordingly, the connecting wire 61, which is disposed on the piezoelectric sheet 41 to connect the individual electrode 35 to the vertical electrode 62 in the through-hole 60a, is also located within the area of the pressure chamber 10. Meanwhile, the surface wire 63 connected to the other end of the vertical wire 62 is disposed on the upper or exterior surface of the dielectric film 60. Hence, in the region not corresponding to the pressure chambers 10, the piezoelectric sheet 41 as well as the dielectric film 60 are interposed between the surface wires 63 and the common electrode 34, making the piezoelectric sheet 41 not directly affected by the electric field, at this region. Thus, the piezoelectric sheet 41 does not deform at this region, and there does not occur a crosstalk with the pressure chamber(s) 10 in the vicinity of the surface wire 63 supplied with the voltage, due to the deformation of the sheet 41 at this unintended region. In this way, the ink ejection characteristics is prevented from varying among the pressure chambers 10, or from nozzle to nozzle.

Meanwhile, a part of the piezoelectric sheet 41 is directly sandwiched between each connecting wire 61 and the common electrode 34, with the connecting wire 61 located within the area of the corresponding pressure chamber 10 in plan view. This may contribute to the ejection of ink droplets, but virtually never deteriorates the ink ejection characteristics, and at least has nothing to do with a crosstalk.

The surface wires 63 extend on the dielectric film 60 from the connecting points with the vertical wires 62 into the area extending along the longer base 21a of the trapezoidal shape of the actuator unit 21. In this area, the connecting terminals 64 are formed for the respective surface wires 63, and are connected with the FPC 50. This arrangement facilitates the working operation for connecting the FPC 50 to the connecting terminals 64 with reliability in the production process of the inkjet head unit 1, thereby enhancing the electrical connection therebetween.

A part of each of the surface wires 63 (except some of them) is located over the pressure chamber or chambers 10 but not over any individual electrode 35, as described in detail in paragraph [0033] above. This increases the space for arranging the surface wires 63, enabling to widen the spacing between the adjacent surface wires 63 and to enhance the density of the wiring on the actuator unit 21. The portion of the pressure chamber 10 over which the surface wire 63 is allowed to be disposed is such that even when disposed there the surface wire 63 virtually does not contribute to the deformation of the pressure chamber 10 at all, structurally. That is, upon voltage application to the individual electrode 35, the portion of the piezoelectric sheet 41 interposed between that individual electrode 35 and the common electrode 34 greatly deforms. Without any surface wire 63 in the region corresponding to the portions of the piezoelectric sheets 41-44 or of the pressure chambers 10 to be greatly deformed, the intended deformation of the pressure chambers 10 is not inhibited.

As described above, in the present embodiment, in addition to the presence of the dielectric film 60 beneath the surface wires 63, the specific way of arranging the surface wires 63 also contributes to prevent the crosstalk. Thus, the crosstalk is prevented with an enhanced reliability.

There will be now described an operation of the actuator unit 21 upon pressurization of the ink in the pressure chamber 10. The direction of the polarization at the piezoelectric sheet 41 of the actuator unit 21 is parallel to the direction of the thickness of the piezoelectric sheet 41. That is, the actuator unit 21 is of the unimorph type, namely, the uppermost one 41 of the piezoelectric sheets 41-44 which is the most remote from the pressure chamber 10 among the sheets 41-44 is an active layer, while the lower three sheets 42, 43, 44 near the pressure chamber 10 are non-active layers. Hence, with the directions of the electric field and the polarization coincident, when the electric potential at the individual electrode 35 is made at a given positive or negative value, the portion of the piezoelectric sheet 41 interposed between the individual and common electrodes and applied with the electric field functions as the active portion, and contracts in a direction perpendicular to the polarization direction, by the piezoelectric transverse effect. Meanwhile, the piezoelectric sheets 42-44 are not affected by the electric field, and therefore do not contract by themselves. Hence, there occurs a difference in deformation in the direction perpendicular to the polarization direction between the uppermost sheet 41 and the other sheets 42-44, causing the piezoelectric sheets 41-44 as a whole to become convex toward the side of the non-active layers 42-44. Since the piezoelectric sheets 41-44 or the actuator 21 are fixed to the upper surface of the cavity plate 22 where the pressure chambers 10 are formed, the piezoelectric sheets 41-44 deforms to be convex toward the pressure chamber 10. This decreases the inner volume of the pressure chamber 10, pressurizes the ink therein, and results in. ejection of a droplet of the ink from the nozzle 8. Thereafter, when the electric potential at the individual electrode 35 is changed back to the level the same as the common electrode 34, the piezoelectric sheets 41-44 are restored to its original shape, restoring the inner volume of the pressure chamber 10, too. At this time, the ink in the manifold 5 is sucked into the pressure chamber 10.

In another driving method, all of the individual electrodes 35 are set in advance to have an electric potential different from that of the common electrode 34. Every time when an ejection request is made, any one of the individual electrodes 35 in accordance with the ejection request is once set to have the same electric potential as that of the common electrode 34. Then, at a predetermined timing, the individual electrode 35 is again set to have the electric potential different from that of the common electrode 34. In this instance, since the piezoelectric sheets 41-44 return to the original shape at a timing when the individual electrode 35 is set to have the same electric potential as that of the common electrode 34, the volume of the pressure chamber 10 corresponding to the individual electrode 35 is increased as compared with that in the initial state (in which the electric potentials of the individual electrode 35 and the common electrode 34 are different from each other), so that the ink is sucked into the pressure chamber 10 form the manifold 5. Thereafter, the piezoelectric sheets 41-44 deform into a convex shape that protrudes toward the pressure chamber 10 at a timing when the individual electrode 35 is again set to have the electric potential different from that of the common electrode 34. As a result, the volume of the pressure chamber 10 is decreased to increase the pressure of the ink, so that the ink is ejected from the nozzle 8 in communication with the pressure chamber 10.

When the voltage is applied to the individual electrode 35, the piezoelectric sheets 41-44 deforms the most greatly at a place corresponding to that individual electrode 35. As described above, at this place the surface wire 63 is not formed, eliminating the inconvenience that presence of the surface wire(s) 63 inhibits the deformation of the piezoelectric sheets 41-44 at the place corresponding to that individual electrode 35. The pressure chamber 10 has the rhombic shape with two acute portions, and the through-hole 60a is formed at the position corresponding to the lower one of the acute portions of the pressure chamber 10 as seen in FIG. 7. The piezoelectric sheets 41-44 is structurally the least deformable, upon voltage application to the individual electrode 35, at the part corresponding to the acute portions of the pressure chamber 10. Hence, the connecting wire 61 and the vertical wire 62 disposed at the position corresponding to this part virtually does not deform the piezoelectric sheets 41-44 at all. According to the physical principles, the connecting and vertical wires 61, 62 will deform the piezoelectric sheets 41-44 when the voltage is applied thereto, just as the individual electrode 35 does. However, since the connecting and vertical wires 61, 62 are located at the position where the piezoelectric sheets 41-44 is structurally less deformable, the deformation of the pressure chamber 10 almost solely depends on the electric field created around the individual electrode 35. Thus, by forming the through-hole 60a at the specific position over the pressure chamber 10, there can be obtained an inkjet printhead free from the crosstalk and exhibiting uniform ink ejection characteristics.

The inkjet head unit 1 as described above enjoys the following advantages.

The arrangement that the dielectric film 60 having a dielectric constant which is smaller than that of the piezoelectric sheets 41-44 is interposed between each surface wire 63 and the piezoelectric sheet 41, minimizes the electrostatic capacity or parasitic capacity created for a surface wire 63 upon voltage application to an individual electrode 35 through the surface wire 63, as well as the unnecessary electric field produced between the surface wire 63 and the common electrode 34. Hence, the driving efficiency of the actuator unit 21 is enhanced, and the ink ejection characteristics is made uniform across the actuator unit 21, at the same time. With the unnecessary electric field between the surface wire 63 and the common electrode 34 minimized, the deformation of the piezoelectric sheet 41 at the portion interposed between the surface wire 63 and the common electrode 34 is minimized, meaning that the deformation of the piezoelectric sheets 41-44 in the vicinity of that portion is minimized, preventing the crosstalk with a pressure chamber or chambers 10 in the vicinity of the portion. Thus, the print quality is improved.

The arrangement that the dielectric film 60 is formed at the region positionally corresponding to the pressure chambers 10 prevents the crosstalk which would otherwise occur where a surface wire 63 connected to an individual electrode 35 for a pressure chamber is disposed over another pressure chamber. According to this arrangement, the space for arranging the surface wires 63 increases, enabling to widen the spacing between the adjacent surface wires 63. Thus, the formation of the surface wires 63 is facilitated, making it possible to reduce the manufacturing cost of the actuator unit 21 or the printhead 70.

Conventionally, in the case where a large number of pressure chambers are arranged in matrix for achieving printing of high quality at high speed, the crosstalk tended to occur. The inkjet head unit of the present embodiment is applicable to such a case in order to prevent the crosstalk with reliability.

There will be now described several other embodiments of the invention. In the description below, the same elements or parts as those in the first embodiment, or elements or parts at least similar to the counterparts in the first embodiment, will be denoted by the same reference numerals and description thereof is not provided where unnecessary.

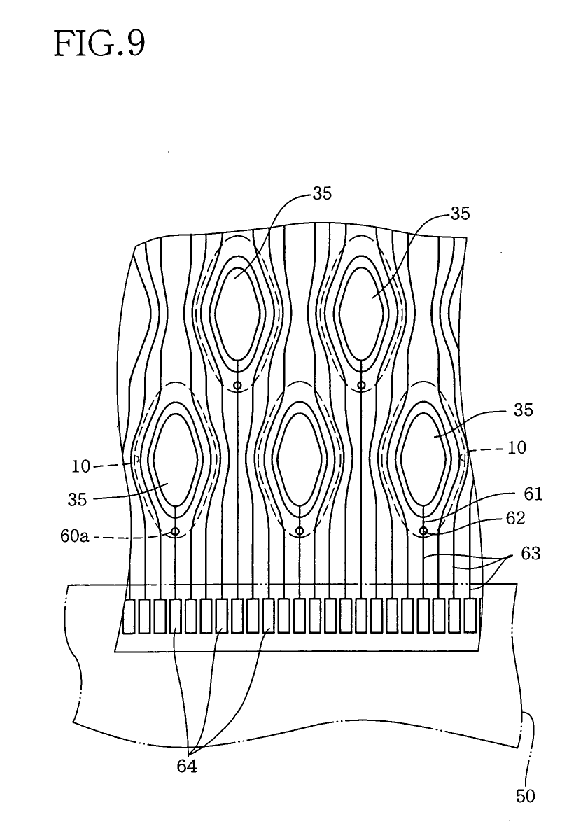

By referring to FIG. 9, an inkjet head unit according to a second embodiment of the invention will be described.

In this embodiment, a surface wire 63 is not disposed over any individual electrode 35, similarly to the first embodiment. The difference of the second embodiment from the first embodiment resides in that a part of the dielectric film 60 is removed in a region positionally corresponding to each individual electrode 35, so as to expose the individual electrode 35 to the outside.

According to this embodiment, the piezoelectric sheets 41-44 is more easily deformable at the place corresponding to each individual electrode 35, enhancing the efficiency of the deformation of the piezoelectric sheets 41-44 and accordingly of the pressure chambers 10.

It is noted that in FIG. 9 only a part of all the surface wires 63 actually provided is shown. That is, in an actual printhead, the number of the surface wires 63 and accordingly the number of the connecting terminals 64 are double the numbers of those represented in FIG. 9.

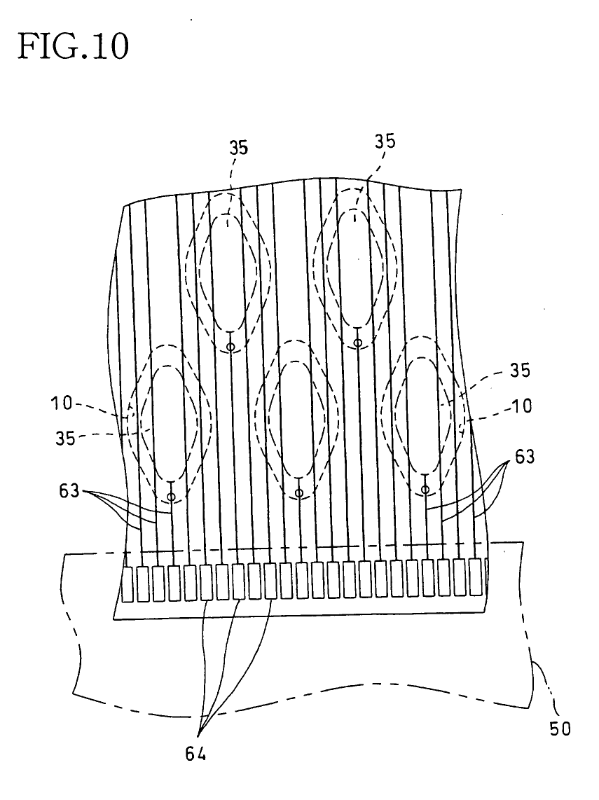

By referring to FIG. 10, there will be described an inkjet head unit according to a third embodiment of the invention.

In the present embodiment, a part of each surface wire 63 (strictly, except surface wires 63 extending from individual electrodes 35 aligned at an edge of an actuator unit 21 on a side to be connected to an FPC 50) is allowed to be disposed over an individual electrode or electrodes 35 as well as over a pressure chamber or chambers 10 different than the one from which the surface wire 63 extends from.

According to this embodiment, the space for arranging the surface wires 63 further increases, enabling to further widen the spacing between the adjacent surface wires 63. Where the way in which the surface wires 63 are disposed over the individual electrode(s) 35 varies from wire 63 to wire 63, the deformation amount of the pressure chambers 10 varies thereamong. Hence, in order to achieve uniform ink ejection characteristics, it is preferable that the positions of the surface wires 63 relative to the respectively corresponding individual electrodes 35, and the spaces or areas occupied by the respective surface wires 63, are uniform among all the surface wires 63.

It is noted that in FIG. 10 only a part of all the surface wires 63 actually provided is shown. In other words, in an actual printhead, the number of the surface wires 63 and accordingly the number of the connecting terminals 64 are double the numbers of those represented in FIG. 10.

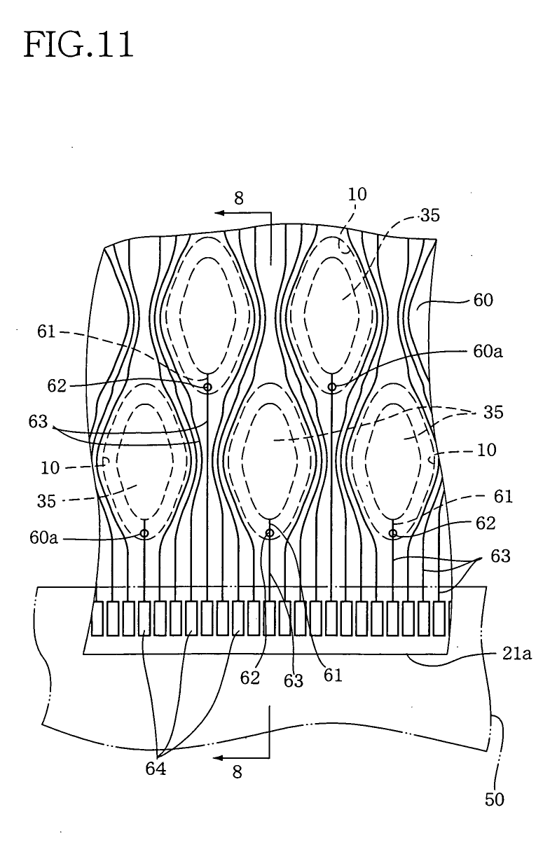

Referring now to FIG. 11, there will be described an inkjet head unit according to a fourth embodiment of the invention.

In each of the above-described first through third embodiments, the surface wires 63 are allowed to extend over the pressure chamber or chambers 10. However, in the present embodiment, the surface wires 63 are disposed to extend only over the interspace between the pressure chambers, and not over any pressure chamber 10.

According to the fourth embodiment, when a voltage is applied to an individual electrode 35 positionally corresponding to a pressure chamber 10, through a surface wire 63 connected to the individual electrode 35, an electric field created around that surface wire 63 does not affect a portion of the piezoelectric sheet 41 positionally corresponding to another pressure chamber 10. Thus, the crosstalk, which would be otherwise caused by presence of the surface wire 63 over the another pressure chamber 10, is prevented further reliably.

As described above, in the present embodiment the surface wires as the first wires are not disposed over any pressure chamber 10, in principle. Strictly, however, a portion of each surface wire (as the first wire) at its one end connected to the vertical wire (as the second wire) is disposed over the pressure chamber from which the surface wire itself extends from, but over a very short distance, as can be seen in FIG. 7. This distance may be zero, that is, each through-hole 60a may be formed on the outline of the corresponding pressure chamber 10 indicated by a broken line, or at a position outside the outline. When the through-hole 60a is formed outside the outline, it is preferable that the through-hole 60a is located as close to the outline as possible.

It is noted that in FIG. 11 only a part of all the surface wires 63 actually provided is shown. In other words, in an actual printhead, the number of the surface wires 63 and accordingly the number of the connecting terminals 64 are double the numbers of those represented in FIG. 11.

In each of the above-described embodiments a through-hole is formed for each pressure chamber and disposed at the position corresponding to one of two opposite longitudinal ends of the pressure chamber. However, each embodiment may be modified such that two through-holes are formed for each pressure chamber and disposed at respective positions corresponding to both of the opposite longitudinal ends of the pressure chamber. This modification is advantageous over the above-described embodiments in terms of versatility. That is, a same dielectric film can be easily usable in both of two types of inkjet printhead units where the surface wires extend upward and downward, respectively, as seen in FIGS. 7 and 9-11, to be connected to the FPC 50. In this modification, it may be arranged such that two connecting wires extend from each individual electrode to be connected to respective vertical wires vertically extending in the two through-holes, and the vertical wires are connected to respective surface wires, or alternatively the vertical wires are connected to a common, single surface wire via respective individual wires. This arrangement is advantageous over the above-described embodiments in terms of fail-safe. That is, where the vertical wires are connected to the respective surface wires, even if one of the two surface wires for a pressure chamber is disconnected or otherwise fails, the other surface wire can work. Where the vertical wires are connected to the common, single surface wire via the respective individual wires, even if one of the two individual wires are disconnected or otherwise fails, the individual electrode is kept connected to the surface wire via the other, normal individual wire.

In each of the above-described embodiments, the shape of the pressure chambers 10 in plan view is the rhomboid. However, the principle of the invention can be equally applicable to cases where the pressure chambers have other shapes in plan view, such as ellipse and rectangle, for instance.

What is claimed is:

1. An inkjet head unit including a printhead comprising:
a flow-path unit having a plurality of nozzles and a plurality of pressure chambers respectively in communication with the nozzles;
an actuator unit having a piezoelectric sheet extending across the pressure chambers, a plurality of individual electrodes disposed on the piezoelectric sheet at respective positions corresponding to the pressure chambers, and a common electrode which is disposed on a surface of the piezoelectric sheet opposite to the individual electrodes, the actuator unit being fixed on a surface of the flow-path unit to vary the inner volume of each of the pressure chambers;
a dielectric film continuously formed on a surface of the actuator unit opposite to the flow-path unit, to extend over a first region not corresponding positionally to the pressure chambers as well as over a second region corresponding positionally to the pressure chambers, the dielectric film having a plurality of through-holes, and a dielectric constant of the dielectric film being lower than that of the piezoelectric sheet;
a plurality of first wires formed on a surface of the dielectric film opposite to the actuator unit, to extend without intersecting with one another; and
a plurality of second wires extending through the through-holes of the dielectric film, and connecting the respective individual electrodes to the first wires.

2. The inkjet head unit according to claim 1, wherein the first wires extend in a substantially same direction.

3. The inkjet head unit according to claim 1, wherein an entirety of each of the first wires is disposed in the first region.

4. The inkjet head unit according to claim 1, wherein a part of one or more of the first wires is disposed in the second region.

5. The inkjet head unit according to claim 4,
wherein the individual electrodes have a shape substantially similar to, but smaller than, that of the pressure chambers, such that when seen in a direction perpendicular to the piezoelectric sheet, the individual electrodes are disposed within outlines of the respectively corresponding pressure chambers,
and wherein the part of one or more of the first wires is disposed on the dielectric film in a third region positionally corresponding to the pressure chambers but not to the individual electrodes.

6. The inkjet head unit according to claim 1, wherein the through-holes of the dielectric film are formed in the second region.

7. The inkjet head unit according to claim 6, wherein the pressure chambers are elongate in a same direction, and each of the through-holes is formed at a position corresponding to at least one of two opposite longitudinal ends of a corresponding one of the pressure chambers.

8. The inkjet head unit according to claim 7, wherein the shape of the pressure chambers is quadrilateral with two acute portions at two opposite longitudinal ends thereof, and each of the through-holes is formed at a position corresponding to at least one of the two acute portions of a corresponding one of the pressure chambers.

9. The inkjet head unit according to claim 1, wherein a part of the dielectric film is removed in a region positionally corresponding to each individual electrode, so as to expose the individual electrode to the outside.

10. The inkjet head unit according to claim 1, wherein the individual electrodes are arranged in a first area, and the first wires extend into a second area extending along the first area.

11. The inkjet head unit according to claim 1, wherein the dielectric constant of the dielectric film is not higher than 1/100 of that of the piezoelectric sheet.

12. The inkjet head unit according to claim 11, wherein the dielectric film is made of one of glass and resin.

13. The inkjet head unit according to claim 1, wherein the pressure chambers are arranged in matrix.

14. The inkjet head unit according to claim 1, wherein the pressure chambers are arranged in at least one row extending in a first direction, and the pressure chambers are elongate in a second direction intersecting the first direction.

15. The inkjet head unit according to claim 14, wherein each of the through-holes is formed at a position corresponding to at least one of two opposite longitudinal ends of a corresponding one of the pressure chambers.

16. The inkjet head unit according to claim 14, wherein the first wires extend generally in a direction intersecting the first direction.

17. The inkjet head unit according to claim 16, wherein the individual electrodes are arranged in a first area, and the first wires extend into a second area extending along the first area.

18. The inkjet head unit according to claim 17, wherein the pressure chambers are arranged in a plurality of rows each extending in the first direction.

19. The inkjet head unit according to claim 18, wherein an entirety of each of the first wires is disposed in the first region.

20. The inkjet head unit according to claim 18, wherein a part of one or more of the first wires is disposed in the second region.

21. The inkjet head unit according to claim 19, wherein each of the through-holes is formed at a position corresponding to at least one of two opposite longitudinal ends of a corresponding one of the pressure chambers.

22. The inkjet head unit according to claim 20, wherein each of the through-holes is formed at a position corresponding to one of two opposite longitudinal ends of a corresponding one of the pressure chambers.
